(19) United States
(12) Patent Application Publication
(10) Pub. No.: US 2009/0307004 A1
(43) Pub. Date: Dec. 10, 2009

(54) METHOD AND SYSTEM FOR MENTORED CREATION OF A PATENT APPLICATION

(76) Inventor: Eugene R. Quinn, JR., Waterford, VA (US)

Correspondence Address: EUGENE R. QUINN, JR., 15159 BANKFIELD DRIVE, WATERFORD, VA, 20197, US

(21) Appl. No.: 12/477,568

(22) Filed: Jun. 3, 2009

Related U.S. Application Data
(63) Continuation-in-part of application No. 11/509,913, filed on Aug. 25, 2006.
(60) Provisional application No. 60/711,984, filed on Aug. 26, 2005.
(60) Provisional application No. 61/130,795, filed on Jun. 3, 2008.

(51) Int. Cl. G06Q 10/00; G06F 7/06; G06F 15/16; G06F 17/30

(52) U.S. Cl. 705/1; 707/3; 709/206; 707/100; 707/E17.014; 707/E17.044

(57) ABSTRACT

A computer implemented method for creating a patent application includes presenting a user with a questionnaire comprising at least one question relating to an invention and receiving answers to the questionnaire. The method also includes conducting a search based on the answers to the questionnaire and creating a preliminary search report based on references located in the search. The method further includes transmitting the preliminary search report to the user and receiving feedback of the preliminary search report from the user. The method still further comprises creating a detailed opinion report based on the feedback received from the user, transmitting the detailed opinion report to the user, and drafting patent application based on the detailed opinion report. The method further contemplates creating a patent application through filling in the blank, whether using a suggested answer templates question by question or by direct insertion of specific information into a patent application template.

### RELATED APPLICATIONS

This application is a continuation in part of and claims the benefit of earlier priority based upon the filing of a U.S. patent application Ser. No. 11/509,913, filed by the inventor of the present application on Aug. 25, 2006, which, in turn, claimed the benefit of U.S. Provisional Patent Application No. 60/711,984 filed by the inventor of the present application on Aug. 26, 2005, the contents of each of which are incorporated herein by reference in their entireties. This application also claims the benefit of U.S. Provisional Patent Application No. 61/130,795 (filed Jun. 3, 2008), the contents of which are incorporated herein in its entirety.

### BACKGROUND OF THE INVENTION

1. Field of the Invention

The present invention relates generally to a method and system for the mentored creation of a patent application.

2. Background

There are many individuals who would like to be able to create their own patent application, or perhaps at least participate in the creation of a patent application in order to keep costs down. The dilemma is that when someone who is not familiar with drafting a patent application attempts to draft a patent application numerous errors, so many of which materially impact substantive rights, are made. In many instances these errors are unknown to the individual who is drafting the patent application, and who may in fact believe they are doing what is appropriate and necessary to perfect rights in their invention.

Over the years there have been various attempts to address this situation, none of which have proven very successful. For example, there are numerous “self-help” or “how to” books available to individuals who find it necessary to do their own drafting. One of the most popular of these books is titled “Patent It Yourself.” In many respect what individuals are coached to do in “Patent It Yourself” will result in the creation of a patent application that is insufficient. In fact, an application that is created by an individual relying on “Patent It Yourself” carries certain tell-tale signs, making it easy for an experienced patent attorney or patent agent to identify. Simply said, in order to coach people into providing a complete disclosure and meaningfully considering how their invention differs over the prior art, those who rely on “Patent It Yourself” explain far to much about the prior art, make numerous admissions that will unnecessarily narrow their ultimate rights and do in the application itself what a patent attorney or agent would do as a part of an Information Disclosure Statement. This is but one illustration of the problems “Patent It Yourself” can create for individuals.

Notwithstanding the above, many individuals simply cannot afford a patent attorney or a patent agent. In these situations they either represent themselves or they simply forego patent protection. Accordingly, some efforts have been made to streamline the collection of information from inventors and through an iterative back and forth process coach them into providing, little by little, ever more detailed information. Through this mentored process individuals may be coached to provide critical information, and learn along the way the type of information required, thereby making them more sophisticated consumers in the future. This, and related efforts to provide mentoring, coaching or review assistance was dealt a significant blow when the United States Patent and Trademark Office (USPTO) changed the rules of practice on Sep. 15, 2008.

On Aug. 14, 2008, the USPTO decided to profoundly change the rules that govern what patent attorneys and patent agents may do when working with independent inventors who are seeking advice but not full representation. While the newly enacted rules do not prohibit consultation with inventors who wish to create their own patent application, the Office of Enrollment and Discipline (OED) within the USPTO has explained that in one-on-one communications, patent attorneys and agents will no longer be allowed to provide limited consulting to inventors. Instead, if an attorney or agent provides specific advice with respect to a patent application the attorney or agent giving the advice must also file the application on behalf of the inventor. The importance of this rule is that inventors will no longer be able to seek the advice of patent attorneys or agents to review what they have done on their own. This interpretation of the new rules significantly changes the landscape in the industry because inventor groups, including the United Inventors Association, have long suggested to independent inventors that if they were going to represent themselves they should, at the very least, have a patent attorney or patent agent review their application prior to filing.

The new rules require all patent application work to be done by or under the direct supervision of a patent attorney. In fact, the rule specifically explains that only a patent attorney or patent agent may engage in the drafting of any legal documents that are to be filed with the USPTO. According to the OED, purely passive assistance in the form of self-help books or software would not run afoul of the new rule, the Office interpretation of the rule or the desire to do away with limited scope representation.

Historically the primary problem with the available “self-help” and “how to” sources (i.e., books and software) is that they only provide passive information. There is no ability to interact with the source in a way that allows for value added input to be delivered by a trained professional. Many people believe that one-size-fits-all when it comes to the preparation of a patent application. The reality, however, is that each individual or entity has unique concerns, obligations, desires and goals, not to mention an innovation that must be unique in at least some important respects if a patent is ever to be obtained. A dilemma, therefore, currently exists with respect to how to provide competent, meaningful, personalized self help assistance while still taking into account the peculiarities and unique characteristics that are inherent in every patentable invention. This has been a real challenge given the new rules of practice that went into effect in September of 2008, and the OED's desire to prevent limited representation or consulting with respect to documents that are to be filed.

In light of the foregoing, what is needed in the industry is an affordable and interactive system that allows individuals, entrepreneurs, start-ups and businesses to obtain the cost savings associated with drafting and filing their own patent applications, while at the same time still obtaining the benefits the assistance of a trained and experienced patent attorney or patent agent. Still further, it would be beneficial to provide a streamlined intake system which can be utilized by patent attorneys and patent agents, so as to collect better information about an invention up front so that much of the time associated with figuring out what the invention can be placed upon the inventor, thereby allowing the patent attorney or patent agent to focus on adding value where a professional touch matters most.

### SUMMARY OF THE INVENTION

With the above in mind, it is therefore an object of the present invention to fill the aforementioned deficiencies in the prior art by providing a method and system for the mentored creation of a patent application.

One aspect of the present invention which enables the streamlining of the patent application process is to work in a collaborative and cooperative manner with the inventor and/or client, who will typically possess a great and detailed understanding of the invention. In working closely with the inventor and/or client it becomes unnecessary for the patent attorney or patent agent to spend the voluminous amounts of time that are traditionally required with respect to first understanding the invention, its capabilities, functions, limits and differences with the prior art. Another aspect of the present invention, which enables the streamlining of a patent application process, is the ability to have trained professionals focus on one particular aspect of the creation of a patent application and become intimately familiar with that particular aspect, which will provide efficiencies often associated with assembly line production of products, but which heretofore has not been applied with respect to the creation of documents created by highly trained professionals, such as patent attorneys and patent agents. Of course, the core of the present invention, which relates to streamlining creation of highly complex documents can be carried out in any number of different contexts, such as but not limited to the creation of licensing agreements, contracts, wills, trusts, business plans and the like.

In order to allow for the assembly line production of a patent application it is necessary to have quality standards and quality review in place. While it may not be absolutely essential, it is strongly preferred for the output of one stage to have all of the required characteristics and information necessary, and have this information presented in a uniform fashion. This allows subsequent professionals to quickly identify the information present, and more importantly perhaps to identify when something is missing. If the output of any one stage is simply random information then the efficiencies are lost, at least in part, and require redoing some or all of the previous work. By meeting certain measurables and presenting information in a standardized fashion the overall process is streamlined while at the same time maintaining high quality standards and ensuring that those who subsequently work on the application can continue to add value in a timely and consistent manner.

Among other things, it is an object of the present invention to provide a method and associated system for mentoring an individual to create a patent application that does not suffer from any of the problems or deficiencies associated with prior solutions.

It is still further an object of the present invention to provide a method and associated system for streamlining the production of a patent application in an assembly line manner, whereby multiple professionals work on select parts of the application, which in some cases will allow certain professionals to develop a specialty in one or more aspects of patent application drafting, further speeding their ability to efficiently speed application creation as a result of familiarity.

Further still, it is an object of the present invention to provide a method and associated system that will allow individuals to create a patent application while still being able to receive at least some input and guidance from a trained professional, such as a patent attorney or patent agent.

Yet further still, it is an object of the present invention to provide a system that allows patent attorneys, patent agents, technology liaisons, paralegals and/or corporations to streamline the intake process by having an inventor answer a series of legally relevant and tailored questions that can form the basis of a first draft of a patent application or invention disclosure.

Yet further still, it is an object of the present invention to provide a system that allows for the training of patent attorneys, patent agents, scientists, engineers and others, including those who aspire to be patent attorneys and patent agents, such as but not limited to law school students.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a flow chart depicting on particular version of the present invention.

FIG. 2 shows a flow chart depicting an alternative version of the present invention.

FIG. 3 shows a flow chart depicting still another version of the present invention.

FIG. 4 shows a flow chart depicting yet another version of the present invention.

FIG. 5 is a screen shot illustrative of one aspect of the overall system.

FIG. 6 shows an alternative screen shot illustrative of one aspect of the overall system.

FIG. 7 is a screen shot showing a close up view of a particular aspect illustrative of the overall system.

FIG. 8 is a screen shot showing a close up view of a particular aspect illustrative of the overall system.

FIG. 9 is a screen shot showing help text, which is a part of the overall system.

### DETAILED DESCRIPTION OF THE DRAWINGS

The present invention is directed to a method and system for the mentored creation of a patent application.

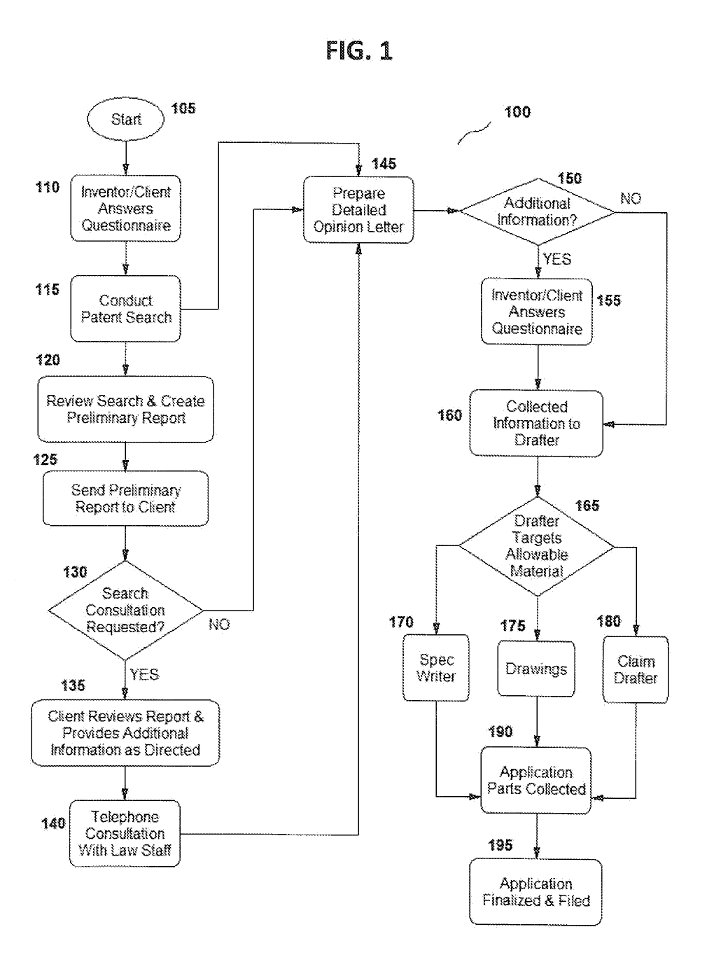

Referring now to the figures, FIG. 1 shows an overall view of one particular version of the system and method 100. At the start 105 of the process the inventor or client (hereinafter “user”) will contact a patent attorney, patent agent or representative, such as a secretary, paralegal or clerical assistant, for example, (all of which are referred to hereinafter as “patent professional”) to indicate an interest in obtaining a patent, filing a patent application or conducting a patent search. At this initial stage the user is sent a questionnaire 110, which is preferably available online through a system accessible via computer over the Internet or other global communications network. This system preferably allows the inventor or client to create their own, unique username and/or password, which advantageously allows the user to save work in progress and return later to complete the questionnaire. The details of the questionnaire will be described later in this application.

Those skilled in the art will appreciate that this system is dependent upon obtaining information directed to an invention from the user/inventor using a computer implemented method so that a patent application may be drafted using the computer implemented method. Accordingly, a questionnaire is generally necessary in order to obtain such information. The present invention contemplates many forms of a questionnaire. For example, the present invention does not limit a questionnaire to a rigid definition of a question presented to a user. Instead, a questionnaire according to the present invention is intended to include any question or statement that is directed to prompting a user to enter information relating to the invention. The information that is obtained from the user is intended to be defined as an answer, and the answer is that which is used to draft the patent application.

Once the user has completed the questionnaire and has submitted the online form, the answers may be sent via e-mail to the patent professional. It is preferred that the answers be simultaneously transmitted to the user for their records. It is also possible for the answers not to be sent via e-mail, but to be stored in one or more databases that are preferably secure and accessible to the patent professional and/or user through a routine login process. In the case where the answers are stored in one or more databases, it is contemplated that the answers may still be transmitted to the user upon completion, and a message may be transmitted to the user indicating that the patent professional has accessed the user's answers in the database.

Upon receiving the answers to the questionnaire a patent search may be conducted 115. Once the search is complete, the patents, or other prior art, that are located during the search may be reviewed, and a preliminary search report may be created 120. This preliminary search report preferably divides the located prior art into a first category and a second category. The first category may be defined as those located prior art references that are most relevant with respect to the invention in the opinion of the searcher or patent professional reviewing the search. This preliminary patent search report preferably also charts the prior art found by providing a table listing the prior art and the reason why the prior art references were selected. This may be organized, for example, by the patent numbers being positioned on a vertical axis and the features searched on the horizontal axis, thereby allowing for easy visual inspection and ascertaining which prior art references contain certain searched features. The preliminary patent search report may then be sent to the user 125, with such transmission being preferably accomplished through electronic communication means such as via e-mail. Alternatively, the transmission can occur through the uploading of the preliminary patent search report to a server, which is preferably secure, and which allows for the user to log into to view, retrieve and/or download the preliminary patent search report to their own personal computing device.

The user may receive and review the preliminary patent search report and be asked if a search consultation is requested 130. In the ordinary situation a search consultation can be requested either by the user or the patent professional, but in the preferred embodiment the search consultation will be had in every instance. If a search consultation is to occur the user is asked to review the preliminary report 135 and is preferably asked to provide additional information regarding how and why their invention is different from those references found. The step of receiving additional information is best accomplished by having the user submit additional information in writing prior to the search consultation. This will give the patent professional more information about the invention and continue refinement of the key aspects of the invention. The step of receiving additional information can be accomplished by the user sending the additional information via electronic message to the patent professional, or by uploading the additional information to a preferably secure server or computer that will house the information and be accessible for viewing, retrieving or downloading by the patent professional. In the situation where there is an intermediate server where this and other information is uploaded to, the server can act as a backup and/or electronic file cabinet allowing all those substantively involved with the patent application (or who are otherwise authorized to have access) to access documents and document revisions by logging into the system. By introduction of an intermediate server communications between the parties can be kept to a minimum and thereby enhance security. For example, if a patent professional uploads the most recent document requiring attention of the user, an electronic message could be sent to the user merely indicating that their attention is required to a recently uploaded document and that they should log into the server and follow the instructions provided. Similarly, when the user needs to communicate with the patent professional the user could upload the document or information, or perhaps create the information or modify the document right on the server without need to upload or download. Then when the user is complete with the immediately pending action notification could be sent to the patent professional. In this situation the server would act not only as backup, but it would be a hub where all or some of the drafts and information going back and forth could be archived.

During this search consultation 140, which is normally conducted via telephone conference or real time Internet communications means, such as but not limited to VoIP, instant messaging, or any other form of real time or substantially real time communications, as understood by those skilled in the art, the discussion will focus on how the invention is different than those references found. This search consultation can and should be a brainstorming session between the patent professional and user. This process allows for the identification and understanding of the full scope of the invention and particularly identification of what is most likely patentable. By engaging in this unique and cooperative approach the patent professional continues to learn more about the invention and obtain critical input from the user prior to forming our opinion. This is important because after review the most relevant patents inventors are almost always much better able to articulate core aspects of their invention and key differences that may not have previously been known or conveyed. This collaborative approach and brainstorming puts the patent professional in an excellent position to prepare a patent application that has maximum chance of being allowed by the US Patent Office.

At the conclusion of the search consultation 140 the user may once again be asked to provide additional information in writing, which can be transmitted and/or stored as previously discussed. Again, this additional information gained, while perhaps not voluminous at any one time, continues to extract valuable information regarding the invention from the user, who is typically most knowledgeable with respect to the invention, and who has known to them information that if extracted properly will significantly assist the patent professional with respect to drafting a patent application. It is preferred to have the search consultation provided by a patent attorney or patent agent who will then prepare the patentability opinion, but this is not necessary.

Ultimately, the patent professional prepares a patentability opinion 145 that discusses how and why the invention differs from the prior art and what is believed are the patentable aspects of the invention, assuming of course it is believed the invention can be patented. In order to guard against the unauthorized practice of law it is preferred that any opinion or legal advice be provided by a patent attorney or patent agent.

Upon receipt of the patentability opinion the user will be asked to review the opinion. At this point it may be advisable to ask the user if they have any additional information to offer 150. In the preferred situation the user will then proceed to provide answers once again to a detailed questionnaire 155, further providing additional information about the invention. By engaging in this process the user is provided multiple opportunities to interact with a patent professional, brainstorm about the invention, review issued patents and it is extremely likely that at every step addition and sometimes vital information can be extracted from the user. This approach to extracting information is much better than what is ordinarily done to collect information from a user because each step of the way the user provides ever more information, typically with ever more detail. This collection of additional information can be even more effective when coupled together with the asking of subtly different questions and encouraging the user to provide answers without reference back to previous answers. It has been found that the more different ways questions are asked the more different ways information is provided, with sometimes astonishing results. By engaging in this process the user should never be overwhelmed, and can contribute through a deliberative, collaborative and cooperative process. This process has from time to time been referred to by the inventor of this method and system as the “wax on wax off method to creating a patent application,” after the familiar Karate Kid movies where the master little by little was teaching his pupil the art of karate without the pupil ever noticing. By coaxing the information out of the user step by step the level of detail obtained can be extraordinary, and the patent application ultimately prepared is far better and leads to stronger rights with greater scope.

Once the information has been collected it may be sent to the patent professional responsible for drafting the patent application 160. Again, this sending of information can be accomplished by a variety of means, but is preferred to be accomplished via electronic messaging or via uploading and downloading as previously described with reference to an intermediate server that can be used to store information and make the information viewable and retrievable by those with authorization to access the information. In fact, throughout this patent application process, whenever the sending, receiving or collecting of information is discussed it should be readily apparent to those of skill in the art that these steps can be accomplished through the use of computer implemented means, such as electronic messaging, e-mail and the use of an intermediate server capable of storing, archiving and making information available.

Upon receiving the information from the user the patent professional may target allowable material by referring to the portion of the patentability opinion that explains the unique features of the invention as compared with previously discovered prior art. The patent professional can then draft the application themselves, or in the preferred embodiment will either draft the specification 170 or the claims 180. In the most preferred embodiment the patent professional will draft the claims 180 and have another patent professional draft the specification 170. These patent professionals will then exchange information with one being responsible ultimately to make sure that the claimed matter is supported in the specification. By having different individuals involved in the specification drafting and patent claim drafting it ensures two pair of eyes put the application together, strengthening the ultimate patent application by ensuring that one single person did not miss any potentially available patent disclosure that could rightfully be included at the time of filing. Typically a trained patent illustrator will prepare the drawings 175. One or more of the specification 170, drawings 175 and claims 180 can be outsourced if desired. Ultimately the patent professional responsible for filing will accumulate the application parts 190, including all the forms necessary for filing, which may be prepared by clerical staff. The ultimately responsible patent professional will preferably review the entirety of the application, smooth the application as necessary to help ensure that it appears to have been written by a single individual, add disclosure as necessary and put a personal touch or flair; finalizing and filing the patent application 195. The ultimately responsible patent professional may be one who was involved in either the specification writing 170 or claim drafting 180, or may be still another individual altogether, raising to three pair of eyes those who have contributed to the ultimately filed patent application.

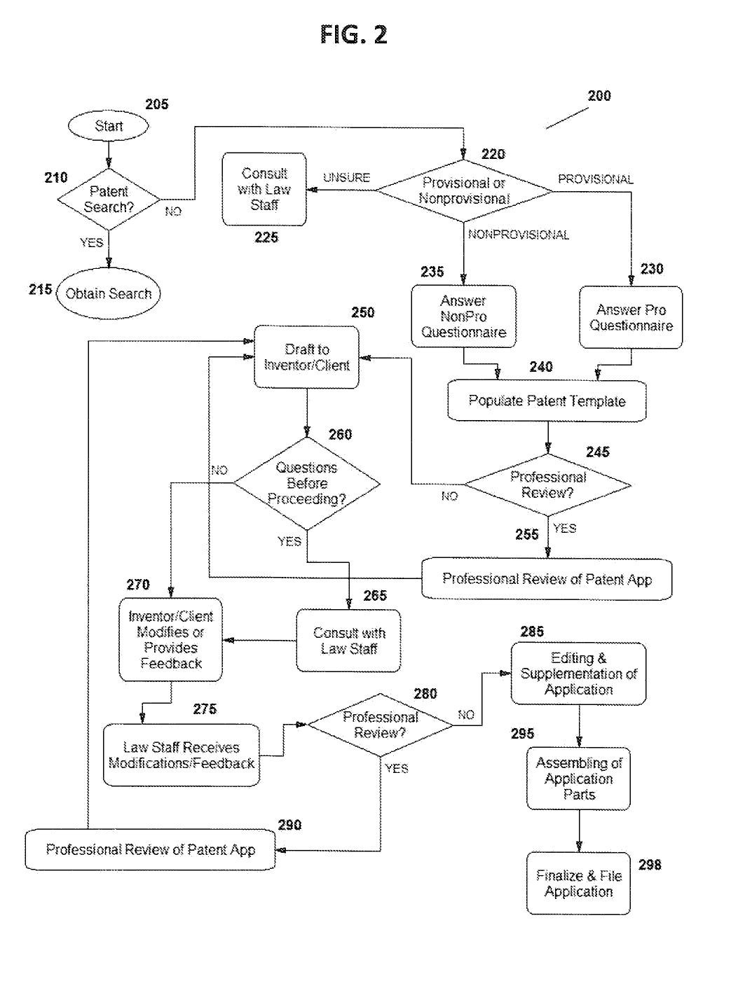

FIG. 2 shows an overall view of one particular version of the system and method 200. The process starts 205 with intake, at which time or shortly thereafter it is determined if a patent search is required or desirable 210. If a search is required or desired a search would be conducted, and would preferably but not necessarily follow the procedure outlined in FIG. 1 through step 145. Upon completion of the patent search, or completion of a patentability opinion if the user wishes to proceed the decision of whether to file a provisional patent application or a non-provisional patent application 220 would be made. If the user is uncertain which type of application is appropriate consultation could be had with a patent professional 225. In either event, upon determination of which type of patent application the user would be sent the appropriate questionnaire, which would either be a non-provisional questionnaire 235 or a provisional questionnaire 230. It is certainly possible that these two questionnaires could be the same and differ only with respect to how the output of the questionnaires is handled.

Upon receiving submission of the questionnaire, the answers may either be manually inserted into a patent template 240, or the answers may be automatically inserted via automatic or semi-automatic computer implementation. Although not pictured, it is also possible that the answers may not be placed immediately into the patent template, but rather reviewed by the patent professional while still remaining in question and answer format. Regardless of how the patent template 240 is populated, or whether the raw answers remain in question and answer format, in the preferred embodiment a patent professional would conduct a professional review 245 if desired or required. In the ordinary case a professional review should be conducted to ensure at a minimum that reasonably adequate information has been provided. If the answers are not adequate or deficient in some way a review can proceed which can include inserting comments, questions, analysis and/or examples that have been previously created through the use of bubble comments, footnotes or endnotes. Of course, in other embodiments it is possible to not only include previously created comments, questions, analysis and/or examples, but to also include some specific, tailored and/or original comments, questions, analysis, examples and/or suggestions. By tailoring previously created comments and/or by inserting original comments, for example, the entire review becomes more meaningful in terms of value added and direction provided to the user. The user can then take these comments, questions, suggestions, examples and analysis into consideration as they provide additional information that will be useful to the patent professionals responsible for drafting the patent application. Through this process the user will also learn more about the requirements for patentability, how to describe the invention and will consider alternatives and additional embodiments. This will lead to a more complete and full patent application, as well as educating the user and making them a better inventor and consumer of patent services in the future.

The present invention contemplates the possibility that a user may bypass the questionnaire and insert information relating to their invention (that which would otherwise be considered answers to the questions, for example) directly into the template. This process can be used, for example, by more experienced users in an effort to speed up the patent drafting process. It is also contemplated that a process such as this may be used by a patent professional that may be working with a user that is not very computer savvy. In other words, the patent professional may, for example, meet with such a user in his/her office and present the questions to the user during a conference. As the user is providing information to the patent professional, the patent professional may enter the information directly into the patent template to thereafter produce a patent application.

After a professional review 245, which is normally but not necessarily conducted by a patent professional, or in the case where a professional review is not requested or desired, the client will receive either a draft patent application or the output of the question and answers 250. In the event the user has questions 260 a consultation with a patent professional 265 can be provided. Either after the consultation 265 or in the event no consultation is requested or required, the user will either modify the draft and/or answers and provide additional information and feedback to the patent professional 270. This additional user information and feedback, in whatever form, is then provided to the patent professional for consideration 275. At this stage another professional review can be obtained 290, with the resulting review and/or information returned to the user 250, or if no additional professional review is necessary, requested or required the collected information can be forwarded to a patent professional for editing, supplementation, drafting and/or integration into the evolving patent application 285. At this point a single patent professional can do the work and assemble the patent application 295 and finalize and file the application 298, or the process outlined in FIG. 1 and discussed above (see 160 through 195) can take place.

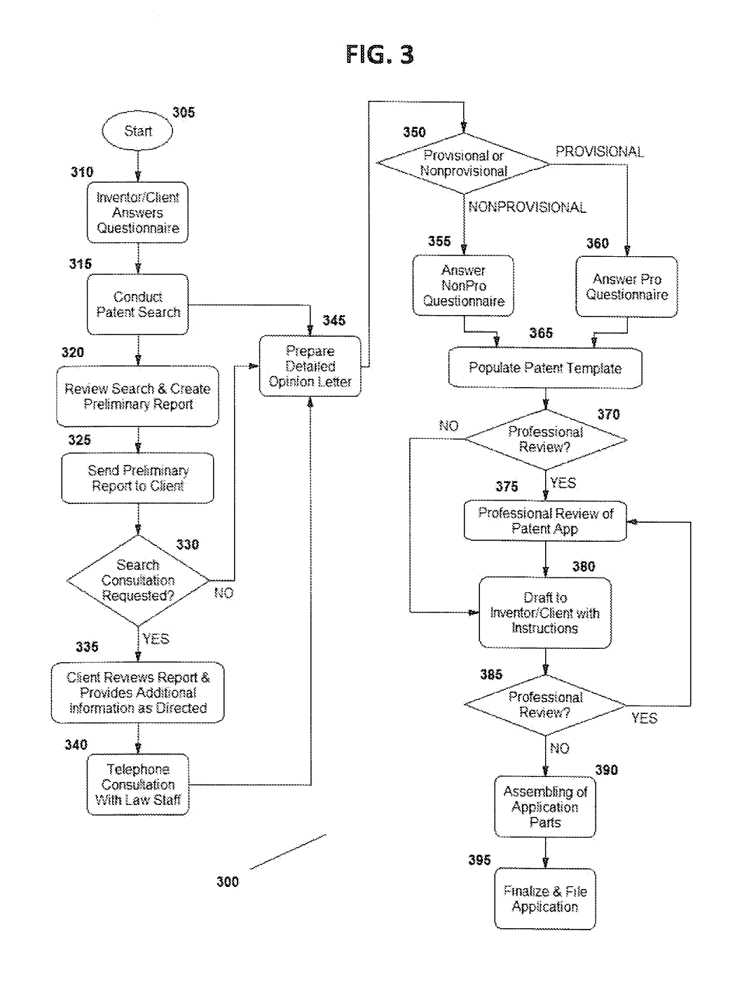

FIG. 3 shows an overall view of one particular version of the system and method 300. At the start 305 of the process the user will contact a patent professional to indicate an interest in obtaining a patent, filing a patent application or conducting a patent search. At this initial stage the user is sent a questionnaire 310, which is preferably available online through a system accessible via computer over the Internet. This system will preferably allow the inventor or client to create their own, unique username and/or password, which will allow the user to save work in progress and return later to complete the questionnaire. The details of the questionnaire will be described later in this application.

Once the user has completed the questionnaire and submitted the online form, the answers will be sent via e-mail to the patent professional. It is preferred that the answers be simultaneously transmitted to the user for their records. It is also possible for the answers not to be sent via e-mail, but to be stored in one or more databases that are preferably secure and accessible to the patent professional and/or user through a routine login process. Upon receiving the answers to the questionnaire a patent search is conducted 315. Once the search is complete the patents found are reviewed and a preliminary search report is created 320. This preliminary search report will preferably divide the patents found into a first category and a second category, with the first category being the most relevant patents found in the opinion of the searcher or patent professional reviewing the search. This preliminary patent search report will preferably also chart the patents found by providing a table listing the patents and the reason why the patents were selected, for example such as by have the patent numbers on a vertical axis and the features searched on the horizontal axis, thereby allowing for easy visual inspection and ascertaining which patents contain which of the searched features. The preliminary patent search report is then sent to the user 325.

The user will receive and review the preliminary patent search report and asked if a search consultation is requested 330. In the ordinary situation a search consultation can be requested either by the user or the patent professional, but in the preferred embodiment the search consultation will be had in every instance. If a search consultation is to occur the user is asked to review the preliminary report 335 and is preferably asked to provide additional information regarding how and why their invention is different from those references found. The step of receiving additional information is best accomplished by having the user submit additional information in writing prior to the search consultation. This will give the patent professional more information about the invention and continue refinement of the key aspects of the invention.

During this search consultation 340, which is normally conducted via telephone conference, the discussion will focus on how the invention is different than those references found. This search consultation can and should be a brainstorming session between the patent professional and user. This process allows for the identification and understanding of the full scope of the invention and particularly identification of what is most likely patentable. By engaging in this unique and cooperative approach the patent professional continues to learn more about the invention and obtain critical input from the user prior to forming our opinion. This is important because after review the most relevant patents inventors are always much better able to articulate core aspects of their invention and key differences that may not have previously been known or conveyed. This collaborative approach and brainstorming puts the patent professional in an excellent position to prepare a patent application that has maximum chance of being allowed by the US Patent Office.

At the conclusion of the search consultation 140 the user may once again be asked to provide additional information in writing. Again, this additional information gained, while perhaps not voluminous at any one time, continues to extract valuable information regarding the invention from the user, who is typically most knowledgeable with respect to the invention, and who has known to them information that if extracted properly will significantly assist the patent professional with respect to drafting a patent application. It is preferred to have the search consultation provided by a patent attorney or patent agent who will then prepare the patentability opinion, but this is not necessary.

Ultimately, the patent professional may prepare a patentability opinion 345 that discusses how and why the invention differs from the prior art and what is believed are the patentable aspects of the invention, assuming of course it is believed the invention can be patented. In order to guard against the unauthorized practice of law it is preferred that any opinion or legal advice be provided by a patent attorney or patent agent.

Upon completion of the patent search, or completion of a patentability opinion if the user wishes to proceed, the decision of whether to file a provisional patent application or a non-provisional patent application 350 would be made. If the user is uncertain which type of application is appropriate consultation would be had with a patent professional. In either event, upon determination of which type of patent application the user would be sent the appropriate questionnaire, which would either be a non-provisional questionnaire 355 or a provisional questionnaire 360. It is certainly possible that these two questionnaires could be the same and differ only with respect to how the output of the questionnaires is handled.

Upon receiving submission of the questionnaire the answers are either manually inserted into a patent template 365, or the answers are automatically inserted via automatic or semi-automatic computer implementation. Although not pictured, it is also possible that the answers may not be placed immediately into the patent template, but rather reviewed by the patent professional while still remaining in question and answer format. Regardless of how the patent template 365 is populated, or whether the raw answers remain in question and answer format, in the preferred embodiment a patent professional would conduct a professional review 370 if desired or required. In the ordinary case a professional review should be conducted to ensure at a minimum that reasonably adequate information has been provided. If the answers are not adequate or deficient in some way a review can proceed which can include inserting comments, questions, analysis and/or examples that have been previously created through the use of bubble comments, footnotes or endnotes. Of course, in other embodiments it is possible to not only include previously created comments, questions, analysis and/or examples, but to also include some specific, tailored and/or original comments, questions, analysis, examples and/or suggestions. By tailoring previously created comments and/or by inserting original comments, for example, the entire review becomes more meaningful in terms of value added and direction provided to the user. The user can then take these comments, questions, suggestions, examples and analysis into consideration as they provide additional information that will be useful to the patent professionals responsible for drafting the patent application. Through this process the user will also learn more about the requirements for patentability, how to describe the invention and will consider alternatives and additional embodiments. This will lead to a more complete and full patent application, as well as educating the user and making them a better inventor and consumer of patent services in the future.

After a professional review 375, which is normally but not necessarily conducted by a patent professional, or in the case where a professional review is not requested or desired, the client will receive either a draft patent application or the output of the question and answers 380. In the event the user has questions a consultation with a patent professional may be provided. Either after the consultation or in the event no consultation is requested or required, the user will either modify the draft and/or answers and provide additional information and feedback to the patent professional 380. This additional user information and feedback, in whatever form, is then provided to the patent professional for consideration. At this stage another professional review can be obtained 385, with the resulting review and/or information returned to the user 380, or if no additional professional review is necessary, requested or required the collected information can be forwarded to a patent professional for editing, supplementation, drafting and/or integration into the evolving patent application. At this point a single patent professional can do the work and assemble the patent application 390 and finalize and file the application 395, or the process outlined in FIG. 1 and discussed above (see 160 through 195) can take place.

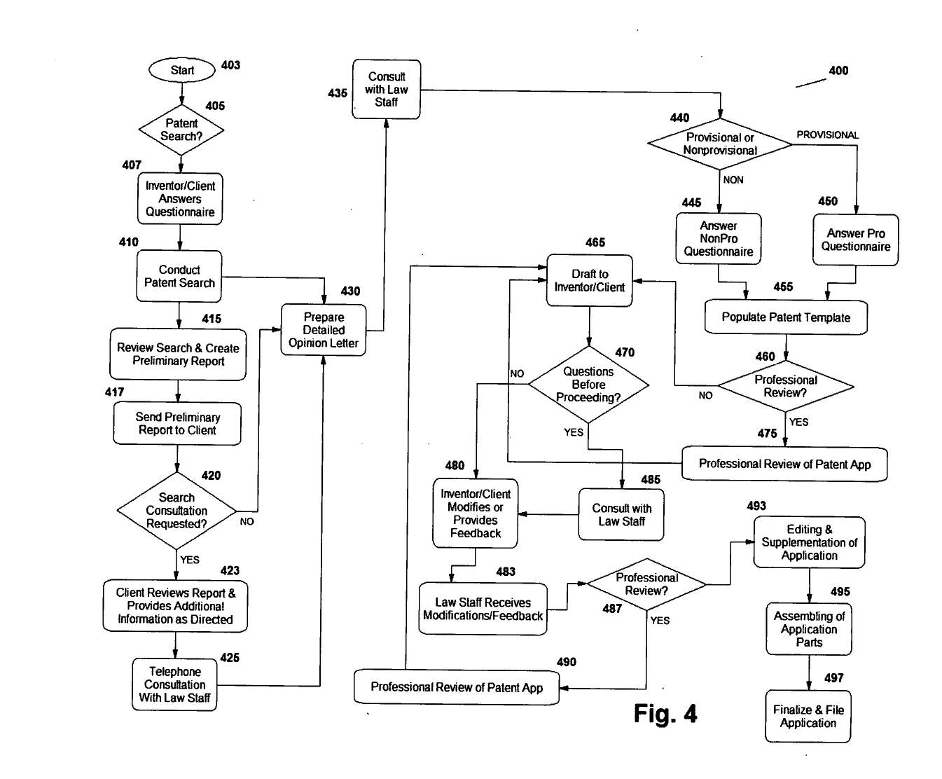

FIG. 4 is largely self explanatory, particularly in light of the previous discussions. FIG. 4 combines various aspects of the process more fully described in FIGS. 1, 2 and 3, and represents one particularly detailed embodiment of the present invention.

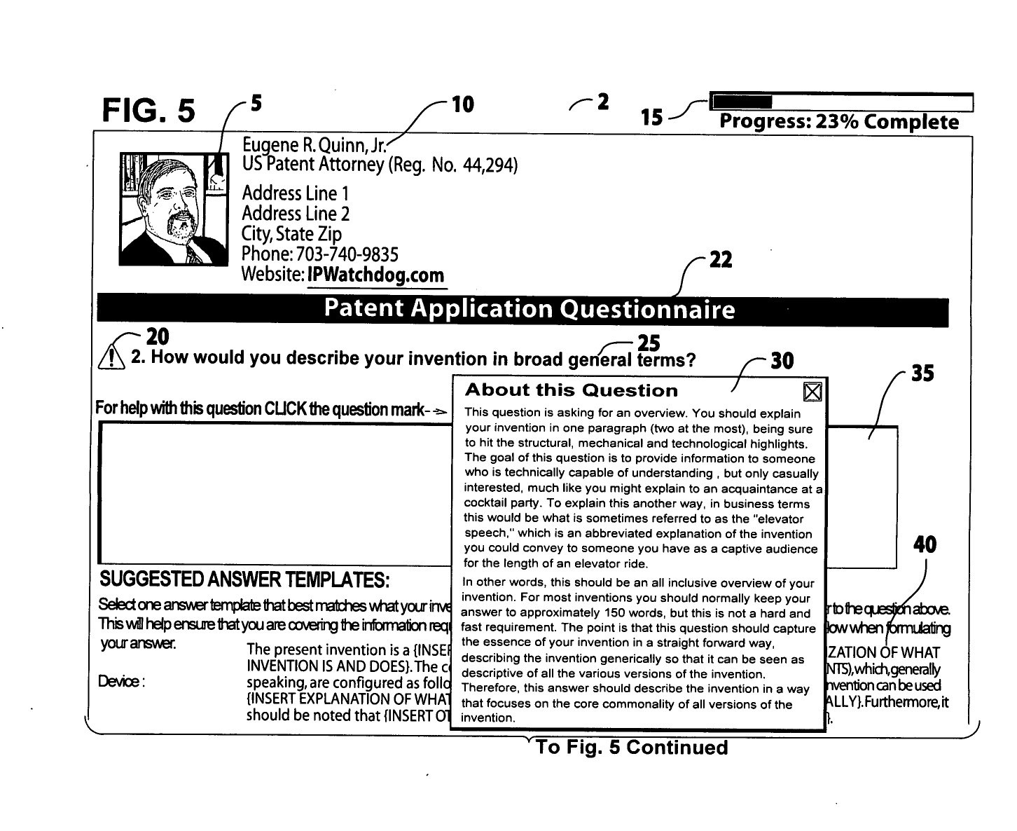

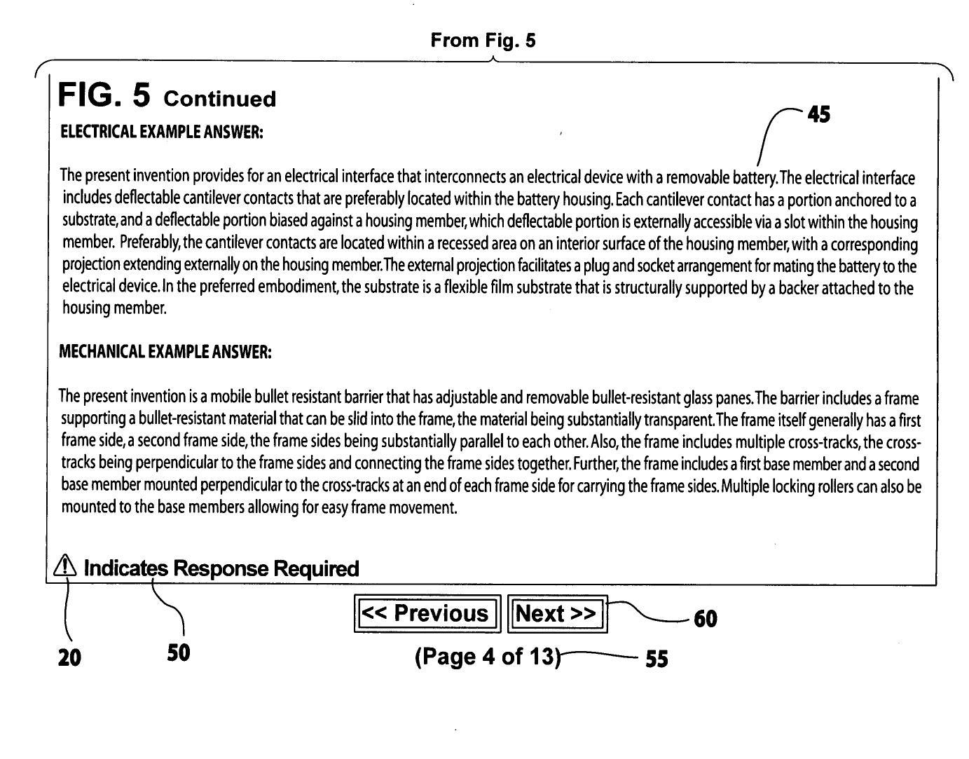

FIG. 5 is a screen shot taken from an application which can be run on a stand-alone computing device, such as a computer, or which can reside on a server or computer accessible through the Internet or an Intranet. In this particular system 2 shows a single question that makes up either the previously mentioned non-provisional patent application questionnaire or a provisional patent application questionnaire. As discussed previously, these questionnaires can be identical, or tailored for one or the other to request and receive more information than the other. Whether as a provisional or non-provisional questionnaire the functionality in the preferred embodiment can be and preferably is the same. Thus, the term “patent questionnaire” will be used from time to time herein to mean both or either the non-provisional patent questionnaire, a provisional patent questionnaire, or can even include a patent search questionnaire provided for purposes of collecting information necessary to understand the invention prior to conducting a patent search.

In this version of the system 2, shown is a rather straight forward question 25, which is preferably short so as to not intimidate the user. Near this question will be a help icon (better shown in later drawings) which when clicked will open a help box 30, which contains textual information about the question, specifically information that explains to the user how the answer to the question will be used and the type of information that is intended to be provoked and thereby collected as a result of the question. Although not shown in this figure, it is also possible to integrate either audio (such as an MP3 recording uploaded to a server and accessible via hyperlink or icon) or video help, which would be available to the user to hear and/or see upon clicking. Through these additional help modules users who process information differently may still receive help, knowing that some individuals respond better to written instructions and others responding better to audio instructions. In the preferred embodiment both some form of audio and/or video and written help instructions will be provided.

There is also an answer box 35 where the user will type in their response to the question. In this embodiment a warning icon 20 is placed in front of the question to indicate that a response to the question is required and that the system will not allow the question to be skipped. This icon can appear anywhere, or it could be optional so as to either not appear or so as to not have any or all of the questions be required. It is, however, preferable to have each question required and to notify the user that each question is required through some visual icon, image or prompt.

One aspect of the present invention that is particularly exciting is the provision of a suggested answer template or templates 40. It is possible to coach the user to provide the particularly desired information by providing them with a sentence or paragraph containing standard language with instructions to insert the desired information in a particular spot. In this version the user could copy and paste the template 40 into the answer box 35 and edit the standard language (if desired) and insert the invention specific information in the appropriate place. It is possible to have one or more suggested answer templates, with answer templates capable of being selected by the user based on the type of invention. For example there can be slightly different answer templates provided for use in the case where the invention is a device, a method, a device and method, a compound, board game, software, software and method, method and system, or software, method and system. By having a variety of templates, including those already mentioned and others, the act of preparing the first draft of a patent application can be as easy as filing in the blank with appropriate information as directed. Thus, the creation of a fill in the blank patent application is envisioned, and has proven to be quite successful, allowing those with even minimal understanding of patent law the ability to prepare a meaningful first draft of a patent application.

FIG. 5 also shows illustrative example answers 45, which are provided to show the user what a suitable answer would look like for a variety of technological areas. There can be one or more illustrative answers provided, and in the preferred embodiment the illustrative answers are geared toward specific technologies with the answers taken from issued U.S. patents. These illustrative answers are tweaked and modified to ensure they are appropriate learning examples and illustrative of the type of information the question is intended to collect. Example answers can be provided for computer related inventions, communications devices, electronic devices, mechanical devices, board games, methods, software, business methods, systems, compounds, optical devices, RFID technology and any other technical specialty.

It should be noted, however, that in the preferred embodiment preliminary questions can be asked of the user regarding the type of invention with subsequent questions displaying only those answer templates 40 and those illustrative example answers 45, which specifically relate to the invention of the user. By providing only that information that is most relevant the number of templates 40 and example answers 45 can be kept to a minimum, which can prevent or limit the user from being overwhelmed with information overload. This is because one important and overriding goal of the preferred embodiment is to make an easy, step by step process that collects relevant information without overwhelming the user. The use of iterative information collection steps, as described infra can be used to collect ever more detailed information little by little, so it is not absolutely required that all information be obtained at any one step.

Also shown in FIG. 5 is branding with a photo 5 of a patent professional, together with the contact information 10 for the patent professional. This branding is optional, but can be useful, particular for those versions of the present invention that are to be provided to patent professionals for use in their own firm or business, or to be used by businesses and corporations directly as a means for collecting information from inventors, clients, engineers and scientists. In this respect the present invention can be used as an intake system by numerous patent professionals or technical liaisons or university technology transfer specialists or anyone for that matter.

Also shown in FIG. 5 is an optional progress bar 15, an optional page indicator showing the page the user is on and how many pages total are in the questionnaire or remain 55, electronic means such as a button or link 60 that allow movement to the next question or back to previous questions, and text that explains to the user that a particular question is required 50. It should be readily apparent to those of skill in the art that the placement of any functions and features can be located anywhere on the screen, so the particular format provided here is purely illustrative.

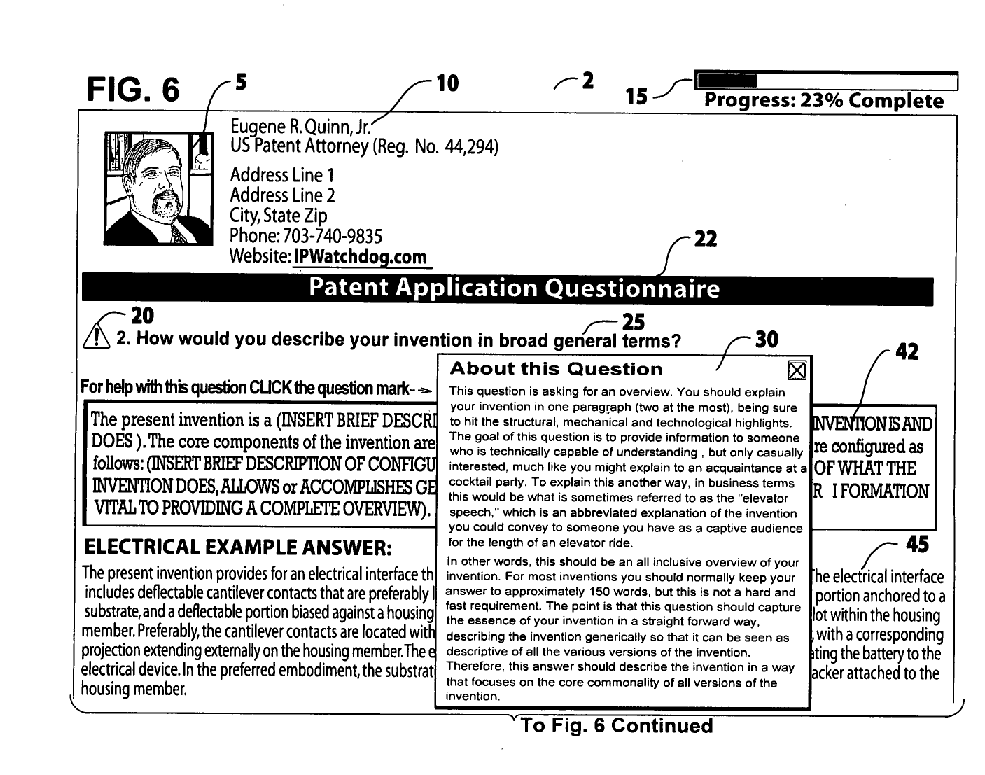

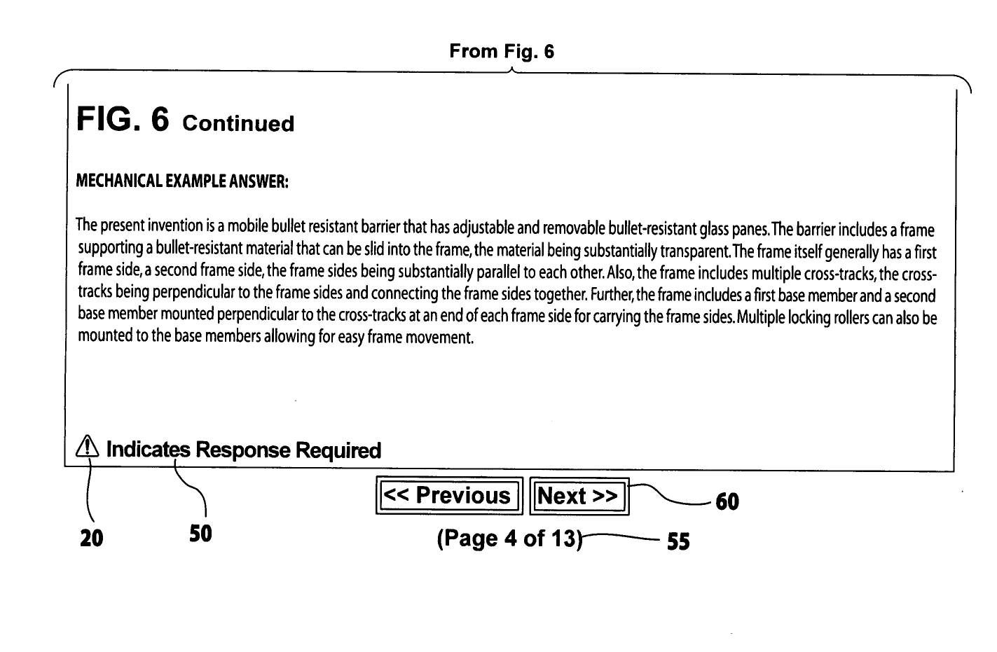

FIG. 6 shows an alternative screen shot 2, which is largely the same as what is shown in FIG. 5. The difference here is that there the suggested answer template 42 appears in the answer box 35. In this version of the system the user has been asked previously to classify or categorize the invention, which would allow for the appropriate answer template to pre-populate each answer box for the questions in the questionnaire. This is preferred because it would make the use of the appropriate answer template more likely. In some embodiments of the present invention the answer box 35 may not be a box, but may simply provide input areas where the user is directed to insert the desired information into the template. In this version of the system the user would not be able to change the standard text, and is preferable because the user would then be forced (or at least encouraged) to provide the desired information in a way that would naturally fit within the suggested answer template, thereby making it more likely that the output of the system could meaningfully create a first draft that flows and uses language desirable for a patent application.

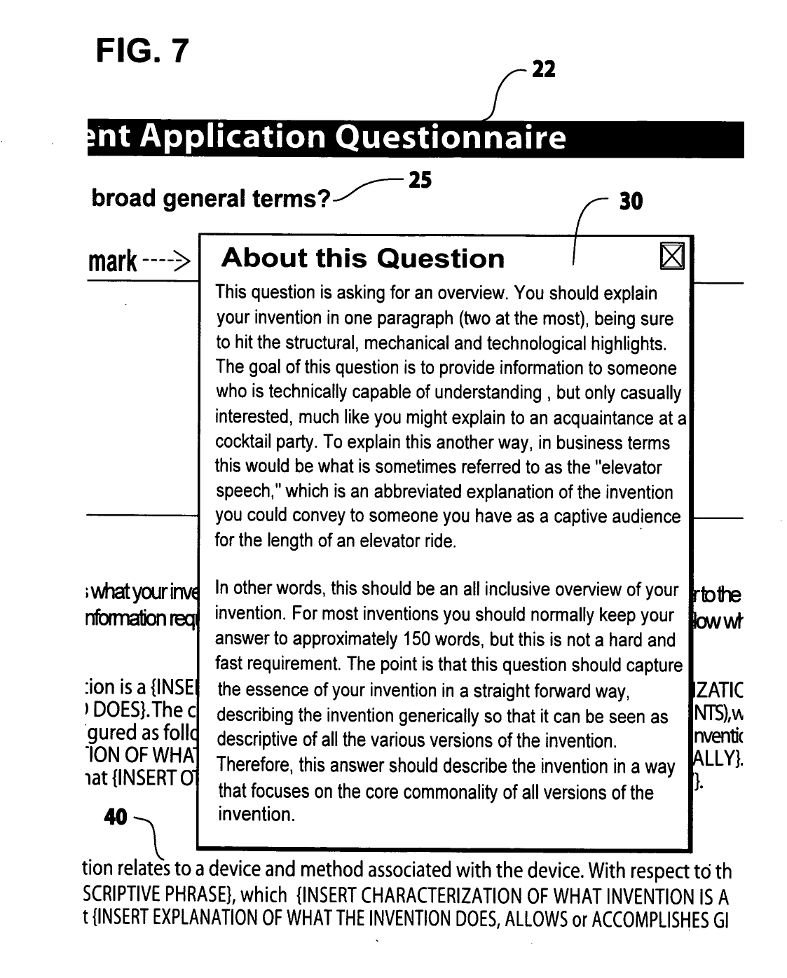

FIGS. 7, 8 and 9 each show a close up of a particular aspect of the screen shots previously discussed. FIG. 7 show the help box 30, which is preferably a pop-up box that floats over the answer box and text, thereby making it more likely that it will be read and considered by the user. In fact, this help box 30 can be activated by clicking on a help icon, or it can appear as each new question loads, much as do interstitial ads. The background for the help box is preferably a color that contrasts with the color scheme used, at least to some degree, making the help text draw more attention. Of course, no particular color is required, and any color (or absence of color) can be used. Of course, the text should be a color that can be readily and easily read given the background.

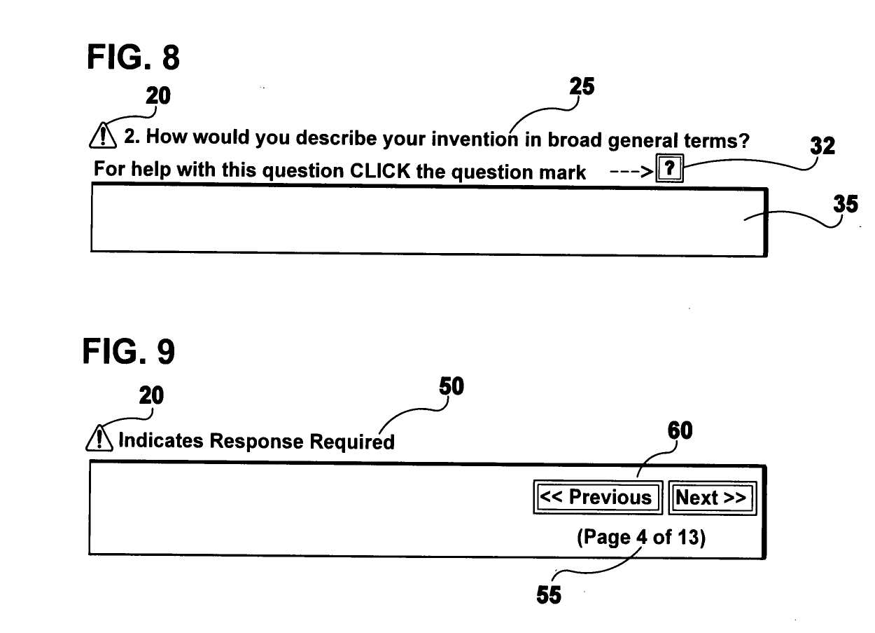

FIG. 8 shows a screen shot providing a close up view of the question 25, the warning icon 20, which reminds the user that the question is required (if in fact that is the case), an answer box 35 and a help icon 32. In this embodiment the help box (not show) would be activated upon clicking on the help icon 32. Any icon or link can be used, and the “question mark” is merely illustrative.

FIG. 9 shows a screen shot showing a close up view of the warning text 50, warning icon 20, both of which are used to remind the user that a question is required (if in fact that is the case), an optional page indicator showing the page the user is on and how many pages total are in the questionnaire or remain 55, electronic means such as a button or link 60 that allow movement to the next question or back to previous questions. While there does need to be some functionality built into the system that will allow users to navigate back and forth and ultimately to review and/or submit the answers, the buttons shown here are illustrative only. It is conceivable that other means could be employed to navigate, such as using browser functionality, functionality provided by an ordinary mouse or even hitting return or enter. It is also feasible to encode hot keys that automatically provide navigation function, but having buttons or links that clearly indicate navigation is preferred.

While the present invention has at times been described above in terms of specific embodiments, particularly in terms of the creation of and review of a patent application or provisional patent application, it is to be understood that the invention is not limited to the disclosed embodiments. This system, method and apparatus can be used to allow for the creation and/or review of any number of documents, including both business related documents and legal and other documents needed by individuals in a non-business context, such as wills, trusts, living wills, powers of attorney, divorce papers, bankruptcy papers, child custody papers, landlord-tenant contracts/documents, real estate agreements/documents and any other type of legal or professional document that may be encountered. In these and all other settings the invention would remain the same. A draft would be provided for professional review. The draft could be created by taking the answers to questions and inserting them into a template and then submitting the draft to the professional reviewer and/or an intermediary, as described above. The questions required to collect the required information would be different, as would the template, but the professional review would be largely the same. Certain the professional review would be looking for different mistakes and omissions depending up on the document and subject matter, but the method, system and apparatus would operate the same. With this in mind, the present invention is intended to cover various modifications and equivalent structures and methods included within the spirit and scope of the claims.

That which is claimed is:

1. A computer implemented method for creating a patent application, the method comprising:
presenting a user with a questionnaire comprising at least one question relating to an invention;
receiving answers to the questionnaire;
conducting a search based on the answers to the questionnaire;
creating a preliminary search report based on references located in the search;
transmitting the preliminary search report to the user;
receiving feedback of the preliminary search report from the user;
creating a detailed opinion report based on the feedback received from the user;
transmitting the detailed opinion report to the user; and
drafting patent application based on the detailed opinion report.

2. A method according to claim 1 further comprising receiving additional information relating to the invention from the user after the detailed opinion report is transmitted to the user and before the patent application is drafted.

3. A method according to claim 2 wherein the additional information relating to the invention received from the user is included in the patent application.

4. A method according to claim 3 wherein the detailed opinion report identifies allowable subject matter relating to the invention.

5. A method according to claim 4 wherein the user is presented with the questionnaire via electronic mail; and wherein the user transmits the answers to the questionnaire via electronic mail.

6. A method according to claim 4 wherein the user accesses the questionnaire via a global communications network; and wherein the answers to the questionnaire are stored on a database accessible via the global communications network.

7. A method according to claim 1 further comprising:
transmitting the patent application to the user for review;
receiving feedback from the user directed to content of the patent application;
incorporating the feedback into the patent application to define a finalized patent application; and
filing the finalized patent application.

8. A method according to claim 7 wherein the patent application is transmitted to the user via electronic mail and wherein feedback is received from the user via electronic mail.

9. A method according to claim 7 wherein the patent application is positioned on a database accessible by the user via a global communications network to provide feedback and wherein the feedback is stored on the database accessible via a global communications network.

10. A method according to claim 9 wherein a message is transmitted to the user indicating that the patent application has been stored on the database and is ready to be reviewed; and wherein the message transmitted to the user requests the user provide feedback to the patent application.

11. A computer implemented method for creating a patent application, the method comprising:
presenting a user with a questionnaire comprising at least one question relating to an invention;
receiving answers to the questionnaire;
populating a patent application template based on the answers to the questions to thereby create a patent application;
transmitting the patent application to the user for review;
receiving feedback on the patent application from the user;
editing the patent application based on the feedback received from the user; and
finalizing and filing the patent application.

12. A method according to claim 11 further comprising presenting a user with an option to file at least one of a provisional patent application and a non-provisional patent application prior to presenting the user with the questionnaire.

13. A method according to claim 12 wherein the questionnaire is a respective at lest one of a provisional patent application questionnaire and a non-provisional patent application questionnaire based on the option selected by the user to file at least one of the provisional patent application and the non-provisional patent application.

14. A method according to claim 11 further comprising conducting a review of the patent application by a patent professional after the patent application has been created by populating the patent template.

15. A method according to claim 11 further comprising conducting a review of the patent application after the patent application has been edited based on the feedback received from the user.

16. A method according to claim 11 further comprising conducting a patentability search and presenting the user with results of the patentability search prior to presenting the user with the questionnaire.

17. A method according to claim 11 wherein the questionnaire is stored on a database and the user accesses the questionnaire via a global communications network; and wherein the answers to the questionnaire are stored on the database and accessible via the global communications network; and wherein the patent application is stored on the database and accessible for review by the user via the global communications network; and wherein the feedback provided by the user is stored on the database and accessible via the global communications network; and wherein the edited patent application is stored on the database and accessible via the global communications network.

18. A method according to claim 17 wherein the database is a secured database.

19. A method according to claim 11 wherein the questionnaire is transmitted to the user via electronic mail; and wherein the answers to the questionnaire are received via electronic mail; and wherein the patent application is transmitted to the user for review via electronic mail; and wherein the feedback provided by the user transmitted via electronic mail; and wherein the edited patent application is transmitted to the user via electronic mail.

20. A computer implemented method for creating a patent application, the method comprising:
presenting a user with a questionnaire comprising at least one question relating to an invention;
providing a suggested answer template to the user;
receiving answers to the at least one question from the user; and
preparing a draft of the patent application based on the answers received from the user.

21. A method according to claim 20 wherein the suggested answer template pre-populates an answer box provided to the user.

22. A method according to claim 21 wherein the suggested answer template is selected by the user based on the type of invention for which the questionnaire is being completed.

23. A method according to claim 22 further comprising sending the draft of the patent application to the user for review.

24. A method according to claim 23 further comprising receiving feedback from the user relating to the draft of the patent application.

25. A method according to claim 24 further comprising incorporating the feedback received from the user into the draft of the patent application to thereby define a finalized patent application.

26. A method according to claim 25 further comprising transmitting the finalized patent application to the user for review.

27. A method according to claim 26 further comprising receiving approval from the user to file the finalized patent application.

28. A method according to claim 25 further comprising filing the finalized patent application.
